(19) United States
(12) Patent Application Publication
(10) Pub. No.: US 2008/0253261 A1
(43) Pub. Date: Oct. 16, 2008

(54) Optical Pickup Having Aberration Correction

(75) Inventors: Petrus Theodorus Jutte, Eindhoven (NL); Sunny Cheng Xianovin, Singapore (SG)

Correspondence Address: BAINWOOD HUANG & ASSOCIATES LLC, 2 CONNECTOR ROAD, WESTBOROUGH, MA, 01581, US

(73) Assignee: ARIMA DEVICES CORPORATION, Road Town, Tortola (BV)

(21) Appl. No.: 12/067,153

(22) PCT Filed: Sep. 19, 2006
(86) PCT No.: PCT/IB06/03833

§ 371 Date: Jun. 3, 2008

(30) Foreign Application Priority Data
Sep. 19, 2005 (EP) 05108590.0

(51) Int. Cl. G11B 7/00

(52) U.S. Cl. 369/112.01

(57) ABSTRACT

An optical pick-up unit is suitable for scanning a first type of record carrier having a first information density and at least a second type of record carrier, the second type of record carrier having a second information density different from the first information density. The optical pick-up unit comprises a first radiation source (16, 86) for emitting a first diverging radiation beam (24) for scanning the first type of record carrier, and at least a second radiation source (48, 96) for emitting a second radiation beam (50) for scanning the second type of record carrier. The optical pick-up unit also comprises a first beam splitter (58, 93, 104) for combining the first radiation beam and the second radiation beam on a common optical path. The first beam splitter is a plane-parallel plate-type beam splitter. A correcting element (20, 22, 72) for astigmatism and coma correction is arranged between the first radiation source and the first beam splitter.

The invention relates to an optical pick-up unit for use in a multi-disc optical player. The invention relates further to an optical player comprising such an optical pick-up unit and to a method for correcting astigmatism and coma in an optical pick-up unit.

An optical pick-up unit (OPU) is the key component of an optical storage system, called optical player, comprising a drive unit and the optical pick-up unit for scanning at least one type of record carriers. The at least one type of record carriers can be either an optical disc (CD, DVD, BD) or a magneto-optical disc (MO). CD (compact disc), DVD (digital versatile disc) or BD (blu ray disc) are optical information storage media, called record carriers, which can be distinguished by the information storage density. CDs are low density information storage media, DVDs are high density information storage media, and BDs are the latest in development of record carriers, allowing an ultra-high density of stored information. Due to the different information storage density of CDs, the DVDs and the BDs, scanning, which means reading, writing and/or erasing of information, from and on the record carrier by a spot of a radiation beam, requires higher demands on the multi-disc optical record system, in particular the optical pick-up unit.

In general, the optical pick-up unit comprises at least one radiation source, in particular a semiconductor laser, emitting at least one radiation beam, which scans the information of at least one type of record carrier, whereby the wavelength of the at least one radiation source is adapted to the information storage density of the at least one type of record carriers. The type of record carrier is characterized by the information storage density, namely low density, high density and ultra-high density.

The optical pick-up unit comprises further an objective lens to form a radiation beam spot out of the radiation beam and focus the radiation beam spot onto an information carrying layer of the record carrier. A detection element detects the radiation beam spot, reflected from the record carrier—called reflected radiation beam, in order to estimate a focus and a radial error signal, which is used to guarantee a stable scanning performance.

An optical pick-up unit in a multi-disc optical player, suitable to scan at least two types of record carriers, comprises in general a first radiation source, emitting a first radiation beam, which is propagating along a first optical path through a first optical branch, and at least a second radiation source, emitting at least a second radiation beam having a second wavelength and propagating along a second optical path through a second optical branch. The first and the second radiation beam are combined onto a common optical path by a first beam splitting device in the form of a cube beam splitting device.

Cost reduction is an essential requirement in the production of optical pick-up units for use in optical players nowadays.

Therefore, it is the object of the invention to provide an optical pick-up unit, which avoids the above mentioned drawback and is economic in production. Further it should meet the requirements of the optical mapping of the radiation beam onto the information carrying surface of the first and the second type of record carriers.

This object is achieved by an optical pick-up unit for scanning a first type of record carrier having a first information density and at least a second type of record carrier, the second type of record carrier having a second information density different from the first information density, the optical pick-up unit comprising: a first radiation source for emitting a first diverging radiation beam for scanning the first type of record carrier, and at least a second radiation source for emitting a second radiation beam for scanning the second type of record carrier, and a first beam splitter for combining the first radiation beam and the second radiation beam on a common optical path, wherein the first beam splitter is a plane-parallel plate-type beam splitter and a correcting element for astigmatism and coma correction is arranged between the first radiation source and the first beam splitter.

Preferably, the first beam splitter is arranged for transmitting the first diverging radiation beam. The first radiation source emits the first radiation beam along an optical path different from the optical path along which the second radiation source emits the second radiation beam.

The advantage of this optical pick-up unit according to the invention is that a plate-type beam splitter is used. A plate-type beam splitter is cheaper in production than a cube beam splitter. This is because a cube consists of two prisms that are glued together in the production process, whereas a plate-type beam splitter consists of a single element. The individual plates are cut from larger plates during the manufacturing process. It is not necessary to involve several process steps. That saves production costs. Plate-type beam splitters for use in the optical pick-up unit are known as wedge-shape plates or plane parallel plates.

Wedge-shaped plates have two plane surfaces, each surface having a normal perpendicular to the respective surface plane, wherein the two surface normals form an angle between each other, wherein the angle has a value not equal zero.

Plane parallel plates have two plane surfaces, being aligned parallel to each other. Hereby, each surface has a normal, which is perpendicular to the surface of the plate, wherein the angle between the normals is substantially zero. A plane parallel plate-type beam splitter is also cheaper than other type beam splitters, such as the wedge plate-type beam splitter.

Because the plate-type beam splitter generates astigmatism and coma in the first, diverging radiation beam transmitted through the plate, the radiation beam spot on the record carrier is disturbed. The amount of astigmatism is dependent on the thickness of the plate-type beam splitter, the refractive index of the plate-type beam splitter, the numerical aperture of the collimating lens and the angle of the normal of the respective plate-type beam splitter with the optical axis of the radiation beam incident on the beam splitter.

The radiation beam spot on the record carrier is also disturbed by coma, caused by the plate-type beam splitter. The coma is as well dependent on the thickness and the refractive index of the plate-type beam splitter, the aperture of the collimator lens and the angle between the normal of the plate-type beam splitter and the optical axis.

The amount of disturbance caused by the astigmatism is in general higher than the amount caused by the coma. This disturbance makes it in general impossible to scan an optical record carrier with two plate-type beam splitters.

The astigmatism and the coma caused by the second plate-type beam splitter to the first optical branch might then be corrected, allowing the use of two plate-type beam splitters.

The spot on the disc must have a very low aberration value in order to avoid low quality read and recording performance. On the other hand, the spot on the detection element must have a large amount of astigmatism in case of astigmatic focusing and preferably no coma.

The astigmatism and coma introduced by the first plane parallel plate is corrected according to the invention by using a correcting element for astigmatism and coma correction arranged between the first radiation source and the first beam splitter. The correcting element is preferably arranged in the first optical branch. Advantageously a correction surface can be applied to an optical element, being arranged in the first optical branch. An optical element, which is arranged in the optical branch anyway can be used to perform the correction of astigmatism and coma, caused by the first plane parallel plate or an extra optical element can be arranged on the first optical path.

According to a first preferred embodiment of the invention, the optical pick-up unit comprises a detection element and a second beam splitter arranged for coupling out a returning radiation beam reflected from the record carrier to the detection element, the second beam splitter being a plate-type beam splitter. The cost of the pick-up unit is further reduced when the first beam splitting device and the second beam splitting device are plane parallel beam splitters. The second beam splitter is preferably of the plane parallel plate type.

The set-up of an optical pick-up unit for scanning a first type of record carriers and at least a second type of record carriers, wherein the second type of record carriers having an information density different from an information density of the first type of record carrier, comprises a first optical branch having a first optical axis, including a first radiation source and at least a second optical branch having a second optical axis including a second radiation source.

The first optical branch may comprise a first beam splitter and the second optical branch at least a second beam splitter. Each plate-type beam splitter comprises normals, the normals being directed perpendicular to the respective surfaces of the first and the second plate-type beam splitters, respectively. The first beam splitter is arranged in the first optical branch with a first angle α₁ between the first normal and the first optical axis and the second beam splitter is arranged in the second optical branch with a second angle α₂ between the second normal and the second optical axis.

In a preferred embodiment of the optical pick-up unit the second beam splitter is arranged in an optical path from the first radiation source to the first beam splitter. The second beam splitter is used for coupling out the returning radiation beam to the detection element. In this embodiment the correcting element is advantageously arranged between the radiation source and the second beam splitter. The arrangement avoids that the correcting element affects the returning radiation beam.

In another preferred embodiment of the invention, the first beam splitter is arranged in an optical path from the first radiation source to the second beam splitter The correcting means may be an optical component arranged between the first radiation source and the first beam splitter. The optical component may be for example a further lens having a correction surface for correcting the astigmatism and coma, generated by the second plane parallel plate to the first optical branch.

According to a further preferred embodiment of the invention the correcting element is a pre-collimator lens having a correction surface for correcting astigmatism and coma. A pre-collimator lens is a lens that may be arranged between the first radiation source and the first plane parallel plate in the first optical branch, which is the branch having the radiation source able to scan the CD. The pre-collimating lens has at least two surfaces, one surface being directed towards the radiation source and the second surface being directed towards the first plane parallel plate. Advantageously the surface being directed towards the radiation source is realized as correction surface, which is able to correct astigmatism and coma, generated by the second plane parallel plate.

The sag of the correction surface is given by the following formula H(r, θ)=A·r³·cos(θ−θ₁)+B·r+C·r²·cos²(θ−θ₂), wherein A is dependent on the generated coma and the wavelength λ of the radiation beam, as well as the refractive index of the lens and B is a surface tilt term and C is dependent on the astigmatism of the plane parallel plate, the wavelength of the radiation beam and the refractive index of the lens.

In a further preferred embodiment, the correcting element is a first grating element in the first optical branch with at least one correction surface, which is able to correct astigmatism and coma, wherein the grating element is arranged between the first radiation source and the first beam splitter.

In some embodiments of the first optical branch a first grating element is arranged anyway in order to generate from the first radiation source at least three radiation beams, one main radiation beam and two satellite radiation beams, which are used to perform a focus and a tracking error correction. That means that the grating element is positioned in the first optical branch. The grating element has two surfaces, one surface which is directed to the first radiation source and a second surface which have the grating structure being arranged towards plane parallel plate. In that case the correction surface may be arranged on the first surface that is directed towards the first radiation source.

In a further preferred embodiment the pre-collimator lens and the first grating of the first optical branch are designed as one optical component, having at least one correction surface, which is able to correct astigmatism and coma.

If the pre-collimating function and the grating function is performed in one optical device, the grating surface is preferably directed towards the first radiation source. The curved surface of the pre-collimating lens may also comprise the astigmatism and coma-correction surface. The realization of two optical functions in one optical component saves further costs.

In a further preferred embodiment of the invention, the first beam splitter is arranged in the first optical branch forming a first angle α₁ between the at least first normal N_{S1} and the first optical axis, the second beam splitter is arranged in the second optical branch forming a second angle α₂ between the at least second normal N_{S2} and the second optical axis, wherein the first angle α₁ and the second angle α₂ are equal. With that the first plane parallel plate and the second plane parallel plate have the same orientation according to the common optical axis and the arrangement of the first and the second plate-type beam splitter under the same angle against the respective optical axis is realizable.

According to a further preferred embodiment of the present invention, the first beam splitter and the second beam splitter are arranged for transmitting the returning radiation beam. The astigmatism incurred by the returning radiation beam in traversing both plane parallel plates can advantageously be used for detecting focus errors.

In such a pick-up unit the first beam splitter and the second beam splitter are preferably arranged at a mutual orientation for cancelling each other's coma introduced in the returning radiation beam. The mutual orientation is preferably such that the angle between the first normal of the first beam splitter and the optical axis of the returning beam is equal to the angle between the second normal of the second beam splitter and the optical axis of the returning beam, the angles being of opposite sign.

Preferably the both angles are equal to 45°. The plate type beam splitter, especially the plane parallel plate, can easily be arranged under 45° in the first and second optical branch, respectively and the common optical branch. The plane parallel plate may be provided with a coating optimized for 45°. Preferably, the first plane parallel plate and the second plane parallel plate are then arranged under the same angle α₁=α₂=45° in the first optical branch and the second optical branch, respectively and also under 45° in the common optical branch.

In a further preferred embodiment, the first beam splitter has a first thickness and the second beam splitter has a second thickness, wherein the first thickness and the second thickness are equal. The astigmatism generated by the second beam splitter, the plane parallel plate, is depends linearly on the thickness of the plane parallel plate.

In a further preferred embodiment, the first beam splitter and the second beam splitter have the same refractive index. The refractive index is influenced by the material of the beam splitter, the plane parallel plate. The first plane parallel plate has a first refractive index and the second plane parallel plate has a second refractive index. In case the first refractive index and the second refractive index can be equal, the plane parallel plates can be fabricated of the same material. If the first and the second plane parallel plate are made of the same thickness and the same material, only one type of plane parallel plates have to be produced. This decreases production costs.

In a further preferred embodiment of the invention, the first optical branch and the second optical branch are rotated with respect to the common optical branch. In this embodiment, the first optical branch and the second optical branch are aligned perpendicular to the common optical branch. In general the first and the second optical branch may be positioned at any angle between the two branches between 0° and 180°. In other words, they can be aligned perpendicular to the common optical branch, but within 180° around the common optical axis. This is possible, because the radiation beam is directed from the respective first and second optical branch by the beam splitting device onto the common optical branch.

It is advantageous to choose a position of the first and the second optical branch, wherein the first optical branch is a different angle segment than the second optical branch. Preferably they are displaced by about 180°.

Another object of the invention is to provide an optical player for scanning a first type of record carriers and at least a second type of record carrier, the second type of record carrier having an information density different from an information density of the first type of record carrier, including at least one optical pick-up unit according to the invention. The use of the optical pick-up according to the invention reduces the cost of the optical player. The optical player includes amongst others a data processing unit and a drive to move the record carrier along the radiation beam spot. The data processing unit has as input an information signal from the detection element and representing information read from the record carrier. The processing unit includes an error correction circuit for correcting errors in the information signal.

The object of the invention is also solved by a method for correcting astigmatism and coma in an optical pick-up unit used in an optical player, being able to scan a first type of record carrier and at least a second type of record carrier, wherein the second type of record carrier has an information density different from an information density of the first type of record carriers, the optical pick-up unit comprising: a first radiation source for emitting a first diverging radiation beam along a first optical axis for scanning the first type of record carrier, and at least a second radiation source for emitting a second radiation beam along a second optical axis for scanning the second type of record carrier, and a first beam splitter for combining the first radiation beam and the second radiation beam on a common optical path, wherein the first beam splitter is a plane-parallel plate-type beam splitter, and astigmatism and coma, caused by the first beam splitter are corrected by a correcting element arranged between the first radiation source and the first beam splitter

Preferably, a detection element and a second beam splitter are arranged for coupling out a returning radiation beam reflected from the record carrier to the detection element, the second beam splitter being designed as plate-type beam splitter. Plate-type beam splitters are cheap in production and easy to mount in the first optical branch and the second optical branch.

According to a further preferred refinement of the method, the plate-type beam splitter is a plane parallel plate.

In a further preferred refinement of the method, the correction of astigmatism and coma is performed using a correction surface of a pre-collimating lens.

In several optical pick-up units the pre-collimating lens is a standard component nowadays. Preferably the pre-collimating lens is arranged between the first radiation source and the first beam splitter.

According to a further preferred refinement of the method, correction of astigmatism and coma is realized by a correction surface of a grating element. Preferably the grating element is arranged between the first radiation source and the first beam splitter.

The grating element is part of the optical pick-up unit and is arranged between the radiation source and the plane parallel plate of the respective optical branch in order to generate the main radiation beam and at least two satellite radiation beams.

According to a further preferred refinement of the method, the correcting element is designed as a pre-collimator lens and a first grating element integrated as one optical component having at least one correction surface for correcting astigmatism and coma. Correction of astigmatism and coma is realized by a correction surface of this element. With that only one optical component instead of two have to be mounted in the optical pick-up unit. This saves costs for components and space.

These and other objects and advantages of the invention will become more apparent from the following description with reference to the accompanying drawings, wherein:

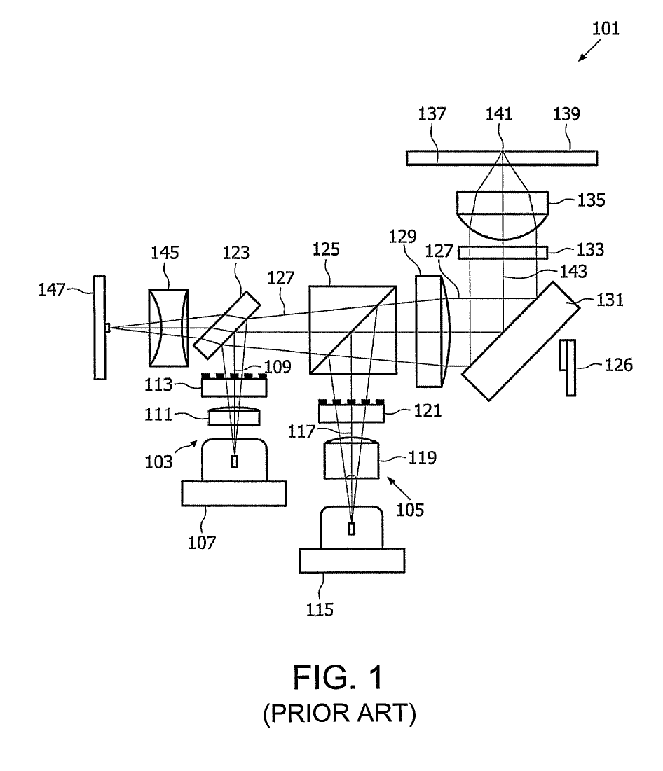

FIG. 1 is a schematic view of an optical pick-up unit having a cube beam splitting device and a plane parallel beam splitting device;

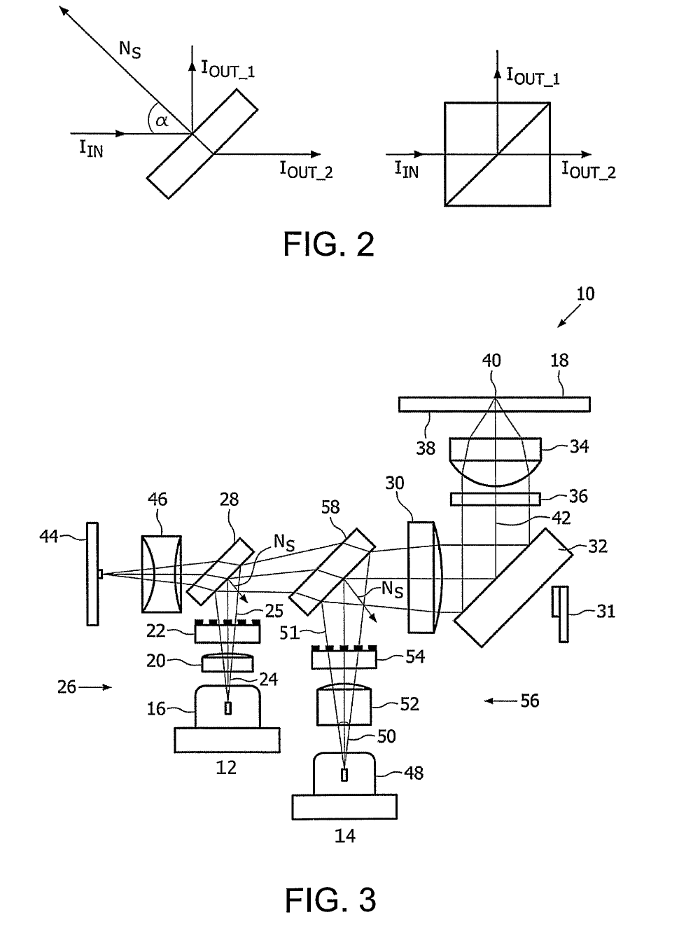

FIG. 2 is a schematic view of the plane parallel plate and the cube beam splitting device, used in the optical pick-up unit shown in FIG. 1;

FIG. 3 is a schematic view of the optical pick-up unit according to the invention;

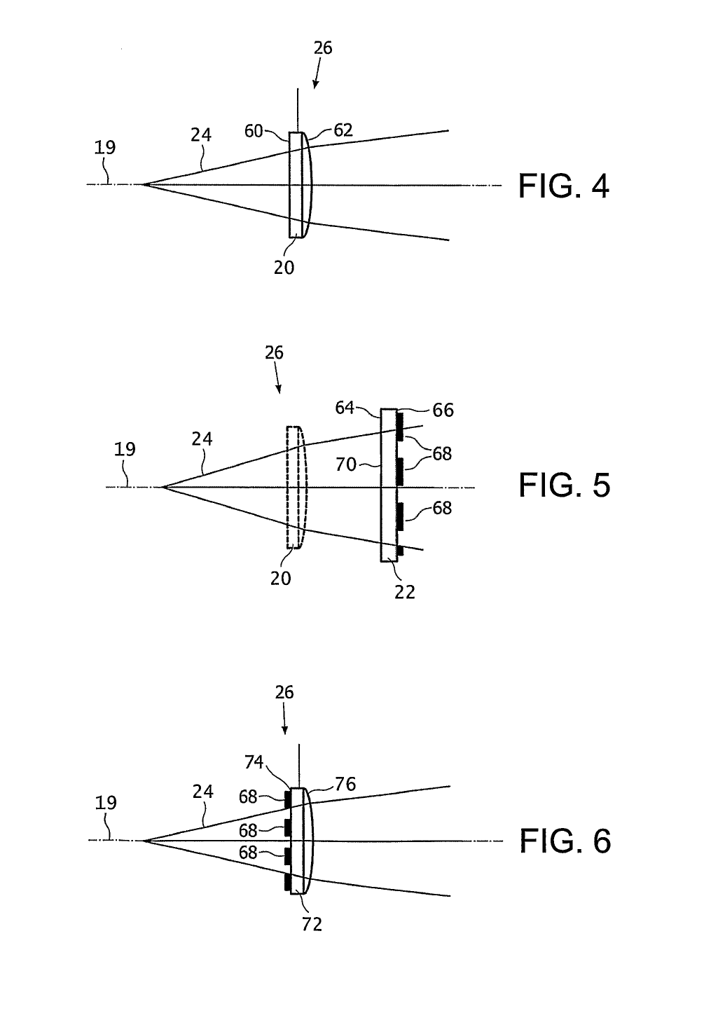

FIG. 4 is a schematic view of a pre-collimator lens with a correction surface;

FIG. 5 is a schematic view of a grating element having the correction surface;

FIG. 6 is a schematic view of an optical component, comprising the grating element and the pre-collimating lens and the correction surface;

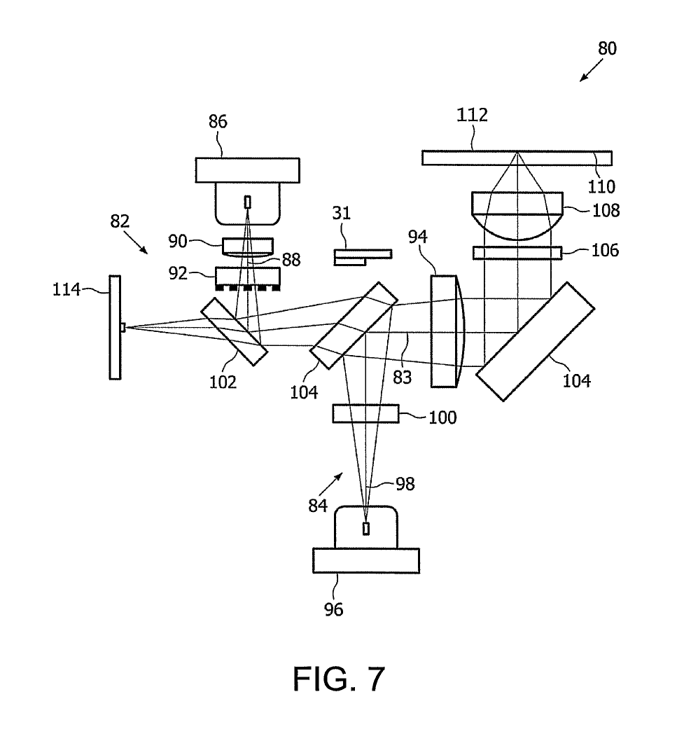

FIG. 7 is a schematic view of a further embodiment of the optical pick-up unit according to the invention;

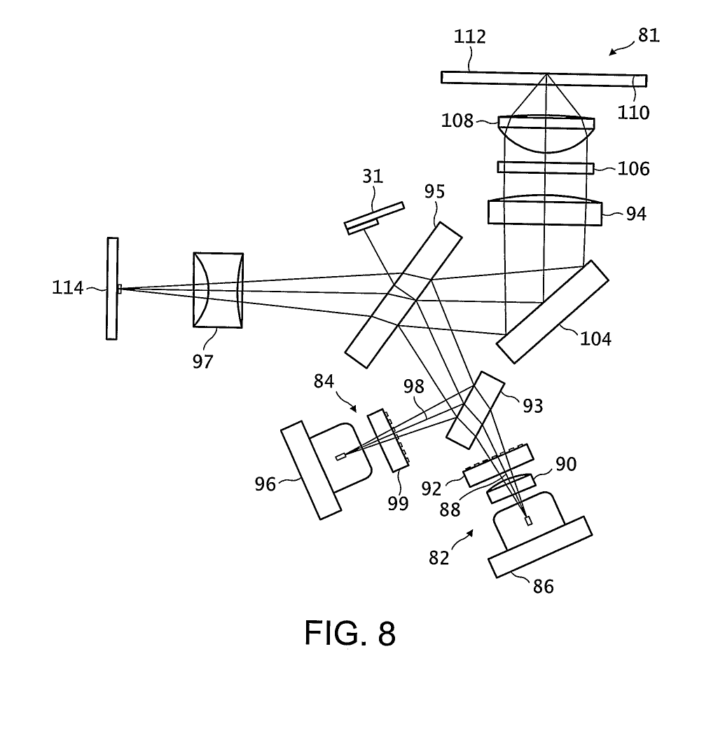

FIG. 8 is a schematic view of another embodiment of the optical pick-up unit according to the invention.

Now, the invention will be described below with reference to the accompanying Figures of the drawing in accordance with the embodiments.

For convenience in the description information storage media are called record carriers. For low density record carriers, such as compact discs, the abbreviation CDs is used, for high density record carriers the abbreviation DVDs is used and for ultra-high density record carriers the abbreviation BDs is used. This includes both read only and/or read and write record carriers.

FIG. 1 shows a schematic view of an optical pick-up unit (OPU) 101, comprising two beam splitting devices, a cube beam splitter and a plate-type beam splitter. The OPU 101 is designed to scan CDs as well as DVDs, and comprises two optical branches 103 and 105. The optical branch 103 is suitable for scanning a first type of record carrier, the branch 105 is suitable for scanning a second type of record carrier. The first optical branch 103 comprises a first radiation source 107, in particular a laser radiation source, emitting a first radiation beam 109 having a first wavelength. The optical branch 103 comprises further a pre-collimating lens 111 and a first grating element 113.

The second branch 105 comprises a second radiation source 115, emitting a second radiation beam 117 with a second wavelength, a beam shaper 119 and a second grating element 121. The optical pick-up unit 101 comprises her a first beam splitting device 125 and a second beam splitting device 123, wherein the first beam splitting device 125 is a cube beam splitter and the second beam splitting device 123 is a plate-type beam splitter, in particular a plane parallel plate.

The optical pick-up unit 101 comprises further a detection component 126, designed as central aperture forward-sense diode.

The first radiation beam 109 or the second radiation beam 117 propagates along the common optical branch 127 passing a collimating element 129 and a mirror element 131 as well as a λ/4 plate 133 and an objective lens 135, until the first or the second radiation beam is directed onto an information carrying layer 137 of the record carrier 139, which can be a first type of record carrier or a second type of record carrier.

A radiation beam spot 141 is formed by the objective lens 133 out of the first radiation beam 109 or the second radiation beam 117, depending on the type of record carrier 139 to be scanned.

The pre-collimator lens 111 is used to couple enough power into the first branch 107, which is usually the CD branch. The first radiation beam 109 is reflected by the second beam splitter 123, being a plate-type beam splitter, and is directed through the first beam splitter 125, being a cube beam splitter, the collimator 129, the mirror 131 and the λ/4 plate 133 to the objective lens 135 which focuses the radiation beam as radiation beam spot 141 onto the information carrying layer 137 of the record carrier 139.

The radiation beam spot 141 is reflected by the record carrier 139 and propagates as reflected radiation beam 143 along the common optical branch 127 backwards passing the first and second beam splitter 125 and 123, respectively, until it is directed by an optical device 145 onto a detection element 147. The plate-type beam splitter 123 causes astigmatism and coma in the common optical branch 127 of the first radiation beam 113 and second radiation beam 117 when they are reflected back from the record carrier 139, respectively.

The second radiation beam 117 is reflected under an angle of 45° by the cube beam splitter 125 and directed onto the common optical branch 127, passing the optical component 129, the mirror 131 and the objective lens 135 and is directed onto the information carrying layer of the record carrier 139.

FIG. 2 shows two embodiments of a beam splitting device, in particular the left part of FIG. 2 shows a plane parallel plate as shown in FIG. 1 as beam splitter 123. The right part of FIG. 2 shows the beam splitting device which is a cube beam splitting device as shown as beam splitting device 125 in FIG. 1. For both types of beam splitters, the propagation of an incident radiation beam I_{IN} is depicted with the propagation path of the radiation inside the beam splitter. The outgoing radiation beam is depicted as I_{OUT} in both cases. There are reflected and transmitted components indicated by I_{OUT}_{_{—}}₁ for the reflected component and I_{OUT}_{_{—}}₂ for the transmitted component.

The beam splitter is an optical component that divides light, in general a radiation beam, into two separate radiation beam portions when the beam splitter is inserted into the optical branch. It can also combine two radiation beams on a common optical path. A plate-type beam splitter comprises a first and a second surface. Each surface of a plane parallel plate type beam splitter has a normal, which is aligned perpendicular to the respective surface. The normal Nₛ forms a specific angle α with the optical axis of the radiation beam incident on the beam splitter. FIG. 2 shows this optical axis as I_{IN}, which is also the optical axis of the optical path along which the incident beam propagates. In FIG. 2, the angle α is 45°; in general the angle is in the range between 30° and 45°. In the embodiment shown the surface facing the incident beam performs the beam splitting function; hence the angle relates to this surface. The beam splitter reflects a portion of the incident radiation beam intensity, indicated by I_{OUT}_{_{—}}₁, absorbs a relatively small portion, and transmits the remaining portion of the intensity of the radiation beam, indicated by I_{OUT}_{_{—}}₂. The portion of the radiation beam I_{OUT}_{_{—}}₁ will be diverted (reflected) in a direction different from the incident radiation beam. The angle between the two directions in this embodiment is 90°.

The production costs for the plate-type beam splitter and cube beam splitter are different due to the production process. The plate-type beam splitter is made of a single piece of the material. The cube beam splitter is constructed by cutting and polishing to precision right-angle prisms with an appropriate interface, wherein the hypotenuse surfaces of the respective prism are glued together. The base material is a glass material and the coating is in general a dielectric coating. The prices of these cube beam splitters are dependent on the size.

Plate-type beam splitters are mirror-type beam splitters which usually have a surface with a semitransparent coating to divide a beam into two or more separate beams.

Plate-type beam splitters are known as wedge plates and plane parallel plates.

A surface of clear glass or film plate may have a metallic or dielectric coating on one side to impart specific reflecting and transmitting characteristics to it. A plate beam splitter is the most common type and has a thin glass substrate in general. Plastic substrates are also known. They are also known as mirror-type beam splitters due to the reflective nature of the coating used. Most of the beam splitters available on the market, have common reflection percentage of 30%, 50% and 70%. The reflective coating is in general optimized between 30° to 45°. A reflecting coating is also available on the back surface of many of the beam splitters and it is also optimized at 45° in general. In general, these beam splitters are sensitive to polarized light.

The cube beam splitter comprises two identical right angle prisms, where the hypotenuse of one of the prisms is coated before the two prisms are cemented together to form a cube. Cube beam splitters offer several advantages over plate-type beam splitters. They are easier to mount, since the 45° beam splitting surface is within the cube.

Since for plate-type beam splitter mounting is at the edge of a thin piece of glass, it cannot handle as much deformation from mounting stresses without effecting the performance.

Also there are not ghost images since most of the reflections within a cube are reflected back in the direction they came and thus do not effect the output radiation beams or images.

In general, the polarization of the radiation is changed when it is incident on a beam splitter oriented at 45°. For randomly polarized radiation beams, a S-polarization state is reflected more than the original amount of reflection and a P-polarization state is reflected less than the average.

Plate-type beam splitters are sensitive to polarized light, the transmission of the S- and P-polarization states can each vary typically as much as 20% from the average at 550 nm for a visible spectrum coating.

In order to save costs the first and the second beam splitting device are preferably designed as plate beam splitting devices; more preferably as plane parallel plates.

FIG. 3 shows a schematic view of the optical pick-up unit according to the invention, comprising two plate-type beam splitters, in particular two plane parallel plate beam splitters.

The optical pick-up unit 10 comprises a first optical branch 12 and a second optical branch 14. The first optical branch 12 comprises a first radiation source 16, preferably, a semiconductor laser, generating a first, diverging radiation beam 24 with a first wavelength. The first optical branch 12 is designed to scan a first type of record carrier, typically a record carrier 18 with the information density of a CD. The wavelength of the first radiation beam is typically 780 nm.

The first optical branch 12 comprises further a pre-collimating lens 20 and a first grating element 22. The first grating element 22 forms out of the first radiation beam 24, in general a main radiation beam and +n^{th}/−n^{th} order satellite radiation beams, which are preferably a zero order main radiation beam 25 and ± first order refracted radiation beams. It is also possible to use other diffraction orders of the main radiation beam to realize the diffracted radiation beams. The diffracted radiation beams are not shown in FIG. 3. The main radiation beam 25 propagates through the first optical branch along a first optical path 26 and is reflected by a second beam splitter 28.

The second beam splitter 28 is in general a partially polarizing beam splitter or a non-polarizing beam splitter. The main radiation beam 25, which has been reflected by the beam splitter 28 is in general collimated by a collimating element 30 and directed by a reflecting element like a mirror 32 to an objective lens 34, passing in general a λ/4 plate 36. The objective lens may also be an objective system including two or more elements having optical power.

The second optical branch 14 for scanning comprises a second radiation source 48, which emits a second radiation beam 50 with a second wavelength for focusing onto the information carrying layer 38 of the record carrier 18. The second radiation beam is in general suitable to scan a DVD and the second wavelength is typically 650 nm.

The second radiation beam 50 passes through an optical element 52, in general a beam shaper, and a second grating element 54 to form a main radiation beam 51 and at least two satellite radiation beams, not shown here.

The second main radiation beam 51 travels along a second optical path 56 and is incident on a first beam splitter 58. The first beam splitter combines the first and second radiation beam onto a common optical path. In this embodiment the common optical path runs from the first beam splitter 58 through the objective lens 34 to the record carrier 18. The first beam splitter 58 is, according to the invention, a plate-type beam splitter, in particular a plane parallel plate.

The objective lens 34 focuses the main radiation beam 25 or 51 onto an information carrying surface 38 or the record carrier 18 and forms with that a main radiation beam spot 40 on the information carrying surface 38 of the record carrier 18.

Radiation reflected on the record carrier 18 in the radiation beam spot 40 forms a returning radiation beam 42, which is directed onto a detection element 44. The returning radiation beam 42 passes the objective lens 34, the λ/4 plate 36, and is reflected by the reflecting element 32 passing the collimating element 30, transmitted through the first beam splitter 58 and transmitted through the second beam splitter 28 and is converged by a so-called servo-lens 46 onto the detection element 44.

The optical pick-up unit comprises further a detection component 31, called forward sense diode, for detecting a part of the unfolded radiation beam.

It is known that the plane parallel plate beam splitter creates astigmatism and coma in the transmitted radiation beam. Coma and astigmatism are harmful in the radiation beam spot that performs the scanning of the record carrier.

The astigmatism and coma caused by the first plate beam splitter 58 in the first radiation beam 24 are according to the invention pre-corrected by an optical component arranged between the first radiation source 16 and the first beam splitting device 58, in this embodiment preferably arranged between the first radiation source 16 and the second beam splitting device 28. The component may be a separate component for correction, but it is preferably the pre-collimating lens 20 and/or the grating element 22 in the first optical branch. In the pre-collimating lens the correction can be made by giving one or both of its surfaces a special shape. In the grating the correction can be made by a special shape of the grating lines on one of its surface or by a special shape of one or both of its surfaces. A single element combining the function of pre-collimating lens and grating may be provided with the astigmatism and coma correcting function.

In the following astigmatism generated by the plane parallel plate is explained in more detail. The astigmatism can be represented by W_{22 RMS}:

$${W}_{22 RMS \text{-} plate} = \frac{( {n}^{2} - 1 ) \cdot {sin}^{2} α}{2 \sqrt{24} \cdot {( {n}^{2} - {sin}^{2} α )}^{3 / 2}} \cdot d \cdot {NA}^{2} , \qquad ( 1 )$$

wherein d is the thickness of the plane parallel plate, n the refracting index of the plane parallel plate, α the angle of the normal of the plane parallel plate with the optical axis, and NA the numerical aperture of the collimator lens 30. In a typical case a is 45°.

The plane parallel plate generates also coma W_{31RMS}, which disturbs the radiation beam spot 40 on the record carrier 18:

$${W}_{31 RMS \text{-} plate} = \frac{- {n}^{2} ( {n}^{2} - 1 ) {sin}^{2} α \cdot cos α}{2 \sqrt{72} \cdot {( {n}^{2} - {sin}^{2} α )}^{5 / 2}} \cdot d \cdot {NA}^{3} \qquad ( 2 )$$

The plane parallel plate has preferably a minimum thickness d=1 to 1.5 mm for sufficient stiffness. When the values of the parameters are taken as: NA=0.075, λ=780 nm, α=45°, d=1 mm and n=1.5, the amount of astigmatism is 196 mλ RMS and the amount of the coma is 11 mλ RMS.

This is an amount of aberration which is not tolerable in the optical pick-up unit and it is not possible to scan the respective record carrier with this.

Therefore, according to the invention the astigmatism and the coma is corrected by introducing astigmatism and coma correction in an optical component arranged in the first optical path. The optical components already present in the first optical branch 12 are the pre-collimator lens 20 and/or the grating element 22, which are arranged preferably between the first radiation source and the first beam splitter.

When the correction is in the form of a curved surface, the sag of the surface is given by:

$$\begin{matrix}H ( r , θ ) = A \cdot {r}^{3} \cdot cos ( θ - {θ}_{1} ) + B \cdot r + C \cdot {r}^{2} \cdot {cos}^{2} ( θ - {θ}_{2} ) , \\ with & ( 3 ) \\ A = \frac{{W}_{31 RMS} \cdot \sqrt{72}}{{L}^{3} \cdot {NA}^{3} \cdot ( {n}_{lens} - 1 )} & ( 4 )\end{matrix}$$

wherein B is a surface tilt term, and

$$C = \frac{{W}_{22 RMS} \cdot \sqrt{24}}{{L}^{2} \cdot {NA}^{2} \cdot ( {n}_{lens} - 1 )} , \qquad ( 5 )$$

with r the radius on the surface in mm, θ the azimuth and θ₁ and θ₂ the orientation angles of the coma and astigmatism, L the optical distance from the radiation source to the correction surface of the optical component. When the surface without correction is flat, the surface with correction is described by H. When the surface without correction has a certain shape, e.g. spherical, the surface with correction is described by this certain shape and the above sag H. The value of B is zero in embodiments of the surface without tilt correction.

FIGS. 4, 5 and 6 show examples according to the invention of one of the optical components in the first optical branch with correction surfaces for astigmatism and coma.

FIG. 4 shows a schematic view of the first optical path 26 having the first optical axis 19 and comprising the first radiation beam 24 and the pre-collimating lens 20. The pre-collimating lens 20 has a first surface 60, facing the radiation source 16, not shown here, and a second surface 62, which is opposite of the first surface 60. The first surface 60 is designed as correction surface with a curvature according to formula (3) to correct astigmatism and coma caused by the first plane parallel plate 58, which is not shown in FIG. 4.

FIG. 5 shows the first optical path 26 with the first radiation beam 24, the pre-collimating lens 20 and the grating element 22. The grating element 22 has two surfaces 64 and 66, wherein the surface 66 comprises the grating structures 68. The surface 64 comprises the correction surface 70 which is able to correct the astigmatism and the coma, caused by the first plane parallel plate 58, wherein the correction surface 70 has a curvature according to the formula (3).

FIG. 6 shows the first optical path 26 with the radiation beam 24. In this embodiment, the pre-collimating lens 20 and the grating element 22 are designed as one optical component 72. The optical component 72 comprises a first surface 74 and a second surface 76, wherein the first surface 74 comprises the grating structure 68. The surface 76 has the function of the second surface 62 of the pre-collimating lens of FIG. 4 and includes the correction for astigmatism and coma caused by the first plate beam splitter 58, where in the curvature of the correction surface 78 is due to the formula (3).

FIG. 7 shows an optical pick-up unit 80, according to a further preferred embodiment of the invention, which is able to scan a first type of record carrier and a second type of record carrier. The optical pick-up unit 80 comprises two optical branches 82 and 84 suitable for scanning different types of record carrier. The first optical branch 82 comprises a first radiation source 86 emitting a first radiation beam 88 with a first wavelength. The optical branch 82 comprises further a pre-collimating lens 90 and a grating element 92.

The second optical branch 84 comprises a second radiation source 96 emitting a second radiation beam 98. The second optical branch 84 comprises further an optical component 100, which is preferably a grating element. The first optical branch 82 comprises the pre-collimating lens 90 which has an astigmatism and coma correction surface.

The common optical branch 83 of the optical pick-up unit 80 comprises further a second beam splitter 102 and a first beam splitter 104, which are both plate-type beam splitters, in particular plane parallel plates.

The first radiation beam 88 is incident on the second plane parallel plate beam splitter 102 and reflected from one of its surfaces. Subsequently, the first radiation beam is incident on the first plane parallel plate beam splitter 104 and transmitted through it. The second radiation beam 98 is incident on the first plane parallel plate beam splitter 104 and is reflected from one of its surfaces. The first and second radiation beam pass a collimating lens 94 and a reflecting element 104, which is in general a folding mirror. The first and the second beam splitter and the collimating lens are arranged in a common optical branch 85. The radiation beam 88 or 98 passes further a λ/4 plate 106 and is focused by an objective lens 108 onto the information carrying surface 110 of a record carrier 112, wherein the record carrier can be a first type of record carrier, for instance a CD, or a second type of record carrier, for instance a DVD. The first radiation beam and the second radiation beam follow a common optical path from the first beam splitter 104 through the objective lens 108 to the record carrier 112.

The optical pick-up unit 80 further comprises a detection element 114, which detects the zero order diffracted radiation beam and the ± first order diffracted radiation beams, which are reflected from the record carrier 112 and directed onto the detection element 114. The detection element 114 comprises several detection element components, not shown here, and provides signals for forming a radial error signal and a focus error signal.

Both plane parallel plates cause astigmatism and coma in the returning radiation beam reflected from the record carrier. In the returning radiation beam a certain amount of astigmatism may be desired for specific methods of generating the focus error signal, but the generated coma is in general not suitable for a proper detection in the detection element 114. Therefore, if the first plane parallel plate and the second plane parallel plate are arranged as shown in FIG. 7, the total astigmatism is a sum of astigmatism from each plane parallel plate, but coma aberrations can be compensated with each other.

Therefore, the configuration shown in FIG. 7 with both plane parallel plates arranged under the same angle α with the returning radiation beam, but with rotated first optical branch and second optical branch is advantageous. In the special embodiment shown in the Figure the angle α is 45°.

Even, if the tracking and focus error procedure is not further explained here, it is to be understood that the procedure disclosed in the patent EP 512 625 B1 for performing a tracking and a focus error is included also in the disclosure of the invention.

The astigmatism and coma caused by the first plane parallel plate 104 in the first radiation beam 88 is corrected by the correction surface of pre-collimating lens 90 or the correction surface of the grating element 92. It is also possible to form the pre-collimating lens 90 and the grating element 92 as one optical component, wherein this optical component has a surface with a grating structure 68 and another correction surface 78 for correcting the astigmatism and coma, according to the embodiment of FIG. 6.

It can be seen from the set-up of the optical pick-up unit 80 in FIG. 7 that the first and the second optical branches are rotated with respect to the common optical branch 85, defining the optical axis of the optical pick-up unit 80.

Although the first and the second optical branch are rotated, the plane parallel plates 102 and 104 have both the same angle, preferably an angle of 45°, between their normals and the optical axis of the first optical branch and the second optical branch, respectively. The astigmatism generated by the two plane parallel plates adds in the returning radiation beam incident on the detection element. The coma, generated by the two plane parallel plates, is advantageously compensated in the returning radiation beam, improving the quality of the signals from the detection element for focus and tracking error estimation of the radiation beam spot.

FIG. 8 shows another preferred embodiment 81 of the optical pick-up unit. Same reference numerals in FIG. 7 and 8 denote similar elements. The first optical branch 82 forms the first radiation beam 88, suitable for scanning a CD-type record carrier. The second optical branch 84 forms the second radiation beam 98, suitable for scanning a DVD type record carrier. A grating 99 in the second optical branch forms a main beam and two satellite beams. A plane parallel plate beam splitter 93 combines the first radiation beam 88 and the second radiation beam 98 onto a common optical path. The angle between the normal on one of the surfaces of the beam splitter and the optical axis of the first radiation beam may be in the range from 25° to 70°; the Figure shows an angle of 45°. The relatively large range gives freedom in the design of the first and second optical branch, in particular their mutual orientation and their orientation with respect to other parts of the optical pick-up unit.

The first radiation beam 88 and the second radiation beam 98 follow a common optical path to a second beam splitter 95, preferably of the parallel plate type. The angle between the optical axis of the common optical path between the two beam splitters and the normal on the surfaces of the second beam splitter may by in a range from 25° to 70°; the Figure shows an angle of 30°. After reflection on the second beam splitter, the radiation beams are reflected on the folding mirror 104, pass through the collimator lens 94 and the λ/4 plate 106 and are focused by the objective lens 108 onto the information carrying surface 110 of the record carrier 112. The common optical path of the first and second radiation beam runs from the first beam splitter 93 via the second beam splitter 95 and the folding mirror 104 till the information carrying surface 110.

The returning radiation beam is transmitted through the beam splitter 95 after reflection on the folding mirror 104. The returning radiation beam is subsequently converged by a servo lens 97 on the detection element 114.

The correction of the astigmatism and coma incurred by the first diverging radiation beam 88 in traversing the oblique plane parallel plate of the first beam splitter 93 is pre-compensated by the correction surface of pre-collimating lens 90 or the correction surface of the grating element 92. It is also possible to form the pre-collimating lens 90 and the grating element 92 as one optical component, wherein this optical component has a surface with a grating structure 68 and a correction surface 78 for correcting the astigmatism and coma, according to the embodiment of FIG. 6.

Although in the above embodiments the first optical branch is designed for forming a radiation beam to scan a CD-type record carrier and the second optical branch for forming a radiation beam to scan a DVD type record carrier, the reverse is also possible, i.e. where the first optical branch is designed for DVD and the second optical branch for CD. Moreover, the invention is not limited to pick-up units and optical players for CD and DVD, but can also be used for DVD en BD and other types of record carrier.

1. An optical pick-up unit for scanning a first type of record carrier having a first information density and at least a second type of record carrier, the second type of record carrier having a second information density different from the first information density, the optical pick-up unit comprising:
a first radiation source for emitting a first diverging radiation beam for scanning the first type of record carrier, and at least a second radiation source for emitting a second radiation beam for scanning the second type of record carrier, and
a first beam splitter for combining the first radiation beam and the second radiation beam on a common optical path,
wherein the first beam splitter is a plane-parallel plate-type beam splitter and a correcting element for astigmatism and coma correction is arranged between the first radiation source and the first beam splitter.

2. The optical pick-up unit according to claim 1, comprising a detection element and a second beam splitter arranged for coupling out a returning radiation beam reflected from the record carrier to the detection element, the second beam splitter being a plate-type beam splitter.

3. The optical pick-up unit according to claim 2, wherein the second beam splitter is arranged in an optical path from the first radiation source to the first beam splitter.

4. The optical pick-up unit according to claim 2, wherein the first beam splitter is arranged in an optical path from the first radiation source to the second beam splitter.

5. The optical pick up unit according to claim 1, wherein the correcting element is a pre-collimator lens having a correction surface for correcting astigmatism and coma.

6. The optical pick-up unit according to claim 1, wherein the correcting element is a first grating element having at least one correction surface for correcting astigmatism and coma.

7. The optical pick-up unit according to claim 1, wherein the correcting element is a pre-collimator lens and a first grating element integrated as one optical component having at least one correction surface for correcting astigmatism and coma.

8. The optical pick-up unit according to claim 2, wherein the first beam splitter and the second beam splitter are arranged for transmitting the returning radiation beam.

9. The optical pick-up unit according to claim 8, wherein the first beam splitter and the second beam splitter are arranged at a mutual orientation for cancelling each other's coma introduced in the returning radiation beam.

10. The optical pick-up unit according to claim 2,wherein the first beam splitter has a first thickness and the second beam splitter has a second thickness, wherein the first thickness and the second thickness are equal.

11. The optical pick-up unit according to claim 2, wherein the material of the first beam splitter and the material of the second beam splitter have the same refractive index.

12. The optical pick-up unit according to claim 1, wherein the first optical branch and the second optical branch are rotated with respect to the common optical branch.

13. An optical player, for scanning a first type of record carrier and at least a second type of record carriers, the second type of record carrier having an information density different from an information density of the first type of record carrier, including at least one optical pick-up unit according to claim 1.

14. A method for correcting astigmatism and coma in an optical pick-up unit used in an optical player, being able to scan a first type of record carrier and at least a second type of record carrier, wherein the second type of record carrier has an information density different from an information density of the first type of record carriers, the method comprising:
providing a first diverging radiation beam for scanning the first type of record carrier, and at least a second radiation beam for scanning the second type of record carrier,
combining the first radiation beam and the second radiation beam on a common optical path, by a first beam splitter, wherein the first beam splitter is a plane-parallel plate-type beam splitter, and
correcting astigmatism and coma, caused by the first beam splitter, by a correcting element arranged between the first radiation source and the first beam splitter.

15. The method according to claim 14, comprising coupling out a returning radiation beam reflected from the record carrier to a detection element by a second beam splitter, the second beam splitter being designed as plate-type beam splitter.

16. The method according to claim 14, comprising correcting astigmatism and coma using a correction surface of a pre-collimator lens.

17. The method according to claim 14, comprising correcting the astigmatism and coma using the correction surface of the grating element.

18. The method according to claim 14, wherein the correcting element is designed as a pre-collimator lens (20, 90) and a first grating element integrated as one optical component having at least one correction surface for correcting astigmatism and coma.
